(19) United States
(12) Patent Application Publication
(10) Pub. No.: US 2012/0238367 A1
(43) Pub. Date: Sep. 20, 2012

(54) METHOD OF EXCHANGING GAME ITEMS, NETWORKED GAME SYSTEM, AND SOCIAL MEDIA

(75) Inventors: Tadayuki KIDO, Tokyo (JP); Taro KANNO, Tokyo (JP); Satoshi UEDA, Tokyo (JP); Yuichi TAKEBE, Tokyo (JP)

(73) Assignee: DeNA Co., Ltd., Tokyo (JP)

(21) Appl. No.: 13/397,766

(22) Filed: Feb. 16, 2012

(30) Foreign Application Priority Data
Feb. 17, 2011 (JP) 2011-32508

(51) Int. Cl. G06F 19/00

(52) U.S. Cl. 463/43

(57) ABSTRACT

A possible fraud action in game-Item exchange can be prevented. When proposing item exchange from Taro to Hanako, Taro does not force Hanako to “exchange for the specified game item.” Instead, the “value information” of Taro's game item in a game is described in an exchange proposal message sent to Hanako. Hanako can see the message and can refer to the “value information”, and select by her own initiative a game item to be presented for the exchange from the game items possessed by her.

When Hanako accesses Hanako's game information with a Hanako terminal and an “item management screen” is displayed on a Hanako terminal display, a button indicating “you have an exchange proposal message, see the details” is displayed. Hanako selects one or more game items from a displayed list. Hanako clicks on a button to “send an exchange accepting message” in an “item exchange screen.”

### TECHNICAL FIELD

The present invention relates to a network game system and/or social media (social networking service) providing environments where users can play games with their user terminals and/or users can share their information with each other by storing game information and/or socializing information in a database and managing the same in a computer system communicating with user terminals such as a personal computer, a tablet terminal, home-use and/or arcade game machines, a portable game machine with a communication function, a mobile phone, an Internet compatible television, and other communication terminals via a communication network. The present invention particularly relates to information processing technology enabling users to exchange game items and/or digital items to be used in a place of information sharing with each other.

### BACKGROUND ART

As well known, Facebook® as social media has created for over 500 million people worldwide a place for information sharing through Internet. The present applicants are operating social media named MobageTown®. A great number of network game systems and social media different in their concepts and scale are used by people in various situations on the Internet.

The social media provides a framework of information processing by computers, as a basic system, that provides each member with storage resource, enables each user to record the information transmitted by each member therein, to show the recorded information to people other than the member him/herself, and enables the members and the other people to put comments on the information they have seen. The social media provides an information processing system for creating community with mutually linked members where information transmitted by one member is communicated to another member in the same community. The social media is constructed with one or more services such as a blog, a web mail, an electronic bulletin board, a chat function, and a game that are to be used by members. The number of users is steeply increasing in the social media called Twitter™.

The network game system provides an information processing system in which a game is played with a plurality of users while they affect each other. In the social game named “Kaito Royale”® which can be played in MobageTown, a user plays a role of a leader of a thief group, earns money by completing missions, and challenges other members to steal their treasures. Sometimes a user founds partnership with other users to play the game together while they give digital items such as a weapon, a protector, a vehicle, and/or treasures to each other.

In social media, personal information, socializing information, socialization management information of each member are stored as correlated to a personal ID and managed. The storage resource used for the purpose is to be called a “member information area” herein. The personal information includes a password, a name, an age, an address, a phone number, an email address, a terminal identification information and contractor identification information of a mobile phone, and the like. The socialization information typically includes information of a blog posted by a member with related information such as others comments to the blog posting, photos and movies as posted, postings on an electronic bulletin board, and web mails. The socialization information constitutes substantive part of information to be exchanged among members in the social media.

In the network game system, the game information is stored for each member and managed. In the game information, a game playing history and/or information on the present condition are described. When a member accesses the game information on a network game system with a terminal such as a mobile phone, a game image is displayed on a terminal screen and the member can play the game from his/her terminal. One feature of the game called social game is that the game information is accessible by others and the member's game information is updated by others' interference actions.

In the network game system, the identifiers (item identification information) of game items (digital items), such as a weapon, a protector, and a vehicle to be used in a scene where the game is played, are described as correlated to an item possession list.

Users can purchase the game items (digital items) as sold or can acquire the game items provided for free on the network game system. The identification information of the acquired digital items is recorded as correlated to the user's own item possession list. Based on such a record, the possessed game items (digital items) can be used timely in a game play scene (or an information sharing scene), thereby providing a change to a game progress status, and/or providing a change to an information sharing scene.

The network game system is configured to compile the information about the provided game items into a database and manage it. The information about the game items includes: the text information containing names, prices, etc., of the items; the visualized information when showing users the game items on terminal screens; the attack capability value and the defense capability value that affect by game items game progress, and the like.

With the network game system, it is possible to communicate with the members making accesses with a mobile phone, etc., and to execute information processing of social games, such as Kaito Royale, and various games to be enjoyed individually, using the information resource constituted as described above. Kaito Royale provided by the present applicants has been enjoyed by many users.

### DISCLOSURE OF INVENTION

### Problems to be Solved by the Invention

The network game system provides a place of information sharing with each other where the game items to be used in a game is handed over to others, and/or taken over from others.

In a certain system, the information about gifting game items is shared among the users; Taro gives Hanako a game item possessed by him, and instead, Hanako gives Taro a game item possessed by her; and management information on their item possession is updated. In this conventional system, such a fraud action can occur that, immediately after the completion of the information processing where Taro gives Hanako the game item, Hanako intentionally interrupts a communicating means with Taro and cancels a promise to give the game item to Taro.

Another network game system is providing such an information processing service that Taro designates Hanako and proposes, to Hanako, exchanging the game item A possessed by Taro for another game item B desired by Taro. This service has problems that whether Hanako possesses the game item B or not is not known, and that the intention of a proposer proposing item exchange is too strongly affected in such a respect that Taro has the initiative in the value judgment on the exchange of his game item A for the other's game item B.

### Invention of Method of Exchanging Game Items

The core of the method of exchanging game items according to the present invention is specified by the following matters 1-8.

1. The method is a method of exchanging game items in a network game system configured to enable carrying out a game process allowing playing game on the user terminals using game information provided to each personal ID stored in a database and an associating process allowing exchanging information among users using user information stored in the database, the network game system being implemented on a computer system configured to communicate with a plurality of user terminals via a communication network.

2. The game information includes an item possession list containing item identification information to which the game item possessed by each user is correlated.

3. The item identification information includes value information indicating a name, an item ID, characteristics, an attribute, a category, a quantity, a capability, a price, a number of use, a utilization condition, etc, of each game item.

4. A first process is identifying a personal ID (1) as one of parties of the exchange and an item identification information (2) correlated to the item possession list of the personal ID (1) as information related to exchanging items, and enabling sending a message of proposal for exchanging the game item of the item identification information (2) with something using the item identification information (2) and a personal ID (3) other than the personal ID (1) to the user terminal identified by the personal ID (3).

5. The exchange proposal message (4) includes value information of the item identification information (2).

6. A second process is enabling sending an exchange accepting message (6) showing intention for exchanging with the item identification information (5) to the user terminal of the personal ID (1) when an item identification information (5) of an exchanging object is determined in the item identification information correlated to the item possession list of the personal ID (3) for responding to the exchange proposal message (4).

7. The exchange accepting message (6) includes value information of the item identification information (5).

8. A third process is registering the item ID corresponding to the item identification information (5) and deleting the item ID corresponding to the item identification information (2) in the item possession list of the personal ID (1), and registering the item ID corresponding to the item identification information (2) and deleting the item ID corresponding to the item identification information (5) in the item possession list of the personal ID (3) when the network game system determines a response to the exchange acceptance message (6) from the user terminal of the personal ID (1) is acceptance.

### Effects of the Invention of Method of Exchanging Game Items

According to the present invention, the above-described fraud action can be completely prevented. Further, in the method according to the present invention, when Taro proposes item exchange to Hanako, although his game item to be exchanged is presented before Hanako, Taro does not force Hanako to “exchange his game item for the specified game item”. Instead, the “value information” of Taro's game item in the game is described in the exchange proposal message to be sent to Hanako.

Hanako can see the massage and refer to the “value information”, and select by her own initiative the game item to be presented for the exchange from the game items possessed by her. In the exchange accepting message for informing Taro of the selected Hanako's game item, the “value information” of the item is described. When Taro sees the message and makes an approval response, the transaction of item exchange is carried out.

### BRIEF DESCRIPTION OF THE DRAWINGS

FIG. 1 is a diagram describing the game item exchange according to the present invention.

### EMBODIMENT

Since a person skilled in the art knows a configuration of a computer information processing system related to a well-known common network game system and social media, new technical matters related to the core of the present invention will be mainly described in the present specification, and well-known common matters will not be described for avoiding redundancy.

### Outline of Network Game System

The network game system, which will be described as an embodiment, provides a service that, as well known, a user accesses a game site on the Internet using his/her personal computer, mobile phone, etc., accesses the user's “my page” information in response to authentication through a personal ID and a password, and accesses, from there, game information, blog information, etc. Further, based on the membership information managed by the network game system, the user can access game information and blog information of other members by specifying other members' personal IDs directly or indirectly, and exchange information among members.

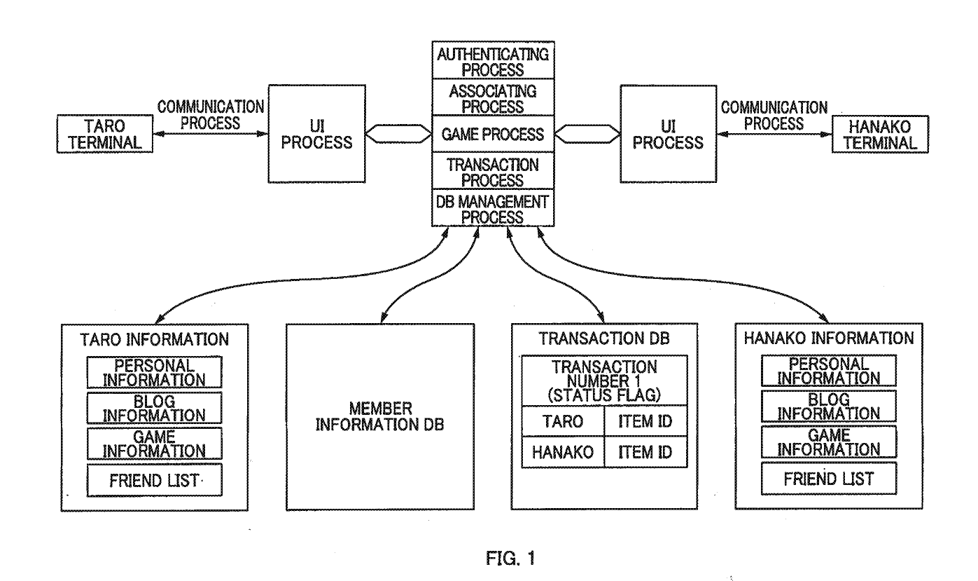

The software configuration of the network game system is explanatorily illustrated in FIG. 1 for the purpose of clearly describing the method of exchanging items according to the present invention. A description will be given, with reference to FIG. 1, of a process until the time when Taro proposes game-item exchange to Hanako and such exchange process is accomplished.

In FIG. 1, a Taro terminal represents a mobile phone of Taro who is the member. A personal ID is assigned to Taro, and the Taro information correlated to the Taro's personal ID is stored in the database of the system. The Taro information. includes: membership authentication information (a password, terminal identification information of a mobile phone, contractor identification information, etc.); personal information such as a name and an email address; a friend list; blog information; and game information. The game information includes an item possession list of item IDs of the game items possessed by Taro. The same applies to a Hanako terminal and Hanako information.

The network game system includes the member information database in which the member's list information and/or contact information is stored, and the member who accesses the system can select a partner in exchanging game items from the member information database.

Further, as described above, the network game system is configured to compile information about the provided game items into a database and manage it. The information about game items includes: the text information containing names, prices, etc., of the items; the visualized information when showing users the game items on terminal screens; the attack capability value and/or the defense capability value that affect by game items game progress, and the like.

Further, the network game system includes the transaction database in order to perform information processing of the game-item exchange method according he present invention. In the transaction database, the information on the transaction process is temporarily stored with a unique transaction number assigned to the game-item exchange transaction between a pair of members.

### First Process

Taro accesses the game information in the Taro information with the Taro terminal, to display an “item management screen” on a Taro terminal display, and click on as button to select a partner of an item exchange on the “item management screen”, thereby shifting to the process of searching for an exchange partner from the member information database. Assuming that Taro has selected Hanako as an exchange partner in this process, then an exchange transaction record (designated as transaction number 1), where a proposer is Taro and a nominee is Hanako, is created, which will be stored in the transaction database. Simultaneously, the “item exchange screen” where a Taro frame and a Hanako frame are arranged side by side is displayed on the Taro terminal display, and a button to “select an item to be exchanged” is displayed in the Taro frame.

When Taro clicks on the button to “select an item to be exchanged” the game items possessed by Taro are displayed in a list form on the Taro terminal display (designs, names, prices, attack capability values, defense capability values of the items, the number of exchangeable items, etc., are displayed), based on the item possession list in the Taro's game information.

When Taro selects one or more game items from the displayed list of the game items, the “item exchange screen” is displayed again on the Taro terminal display, where the item identification information of the selected game item is described in the Taro frame. The item identification information includes the descriptions of the attack capability value and the defense capability value of the game item. When a plurality of game items are selected as exchanging objects, the total value of the attack capability values and the defense capability values for the respective items is described.

When Taro next clicks on a button to “send an exchange proposal message” in the “item exchange screen”, the network game system performs record update processing and message sending processing. In the record update processing, an item ID (a) of the game item selected by Taro is recorded in the exchange transaction record of the transaction number 1 as correlated to the Taro's personal ID, and the status flag of the record is set to “proposing”. In addition, a specific mark is put on the item ID (a) in the Taro's item possession list, and the game item of the item ID (a) is held in the system, so that Taro cannot use the game item in a game. That is, the game item selected by Taro as the exchanging object is set in a state of being unusable until the transaction has been accomplished, thereby preventing occurrence of interference with item use and item exchange.

The message sending processing is information processing where, when Hanako accesses the Hanako's game information with the Hanako terminal and the “item management screen” is displayed on a Hanako terminal display, a button indicating “you have an exchange proposal message, see the details” is displayed on the screen, and when Hanako clicks on the button to “see the details”, the “item exchange screen” where the Taro frame and the Hanako frame are arranged side by side is displayed on the Hanako terminal display. In the Hanako frame at this time, a button to “select an item you may exchange” is displayed. On the other hand, in the Taro frame, displayed is the item identification information (including descriptions of design, a name, and a price of the item, and an attack capability value and a defense capability value for each item and a total value thereof, etc.) with respect to the game item of the item ID (a) selected b Taro as the item to be exchanged.

### Second Process

When Hanako clicks on the button to “select an item you may exchange” on the “item exchange screen” of the Hanako terminal display, the game items possessed by Hanako are displayed in a list form on the Hanako terminal display (designs, names, prices, attack capability values, defense capability values of the items, the number of the exchangeable items, etc., are displayed), based on the item possession list in the Hanako's game information, as described in the Taro's case.

When Hanako selects one or more game items from the displayed list of the game items, the “item exchange screen” is displayed again on the Hanako terminal display, where the item identification information of selected game item is described in the Hanako frame. The item identification information includes the descriptions of the attack capability value and the defense capability value of the game item. When a plurality of game items are selected as the exchanging objects, the total value of the attack capability values and defense capability values for the respective items is described. Hanako compares the value of the item presented by Hanako as the exchanging object and the value of the item to be exchanged by Taro, comparing the item identification information in the Taro frame and the item identification information in the Hanako frame, thereby selecting the item to be presented to make a final decision.

When Hanako next clicks on a button to “send an exchange accepting message” on the “item exchange screen”, the network game system performs record update processing and message sending processing.

In the record update processing, an item ID (b) of the game item selected by Hanako is recorded in the exchange transaction record of the transaction number 1 as correlated to the Hanako's personal ID, and the status flag of the record is set to “waiting for receipt”. In addition, a specific mark is put on the item ID (b) in the Hanako's item possession list, and the game item of the item ID (b) is held in the system, so that Hanako cannot use the game item in a game. That is, the game item selected by Hanako as the exchanging object is set in a state of being unusable until the transaction has been accomplished, thereby preventing occurrence of interference with item use and item exchange.

The message sending processing is information processing where, when Taro accesses the Taro's game information with the Taro terminal and the “item management screen” is displayed on the Taro terminal display, a button indicating “you have an exchange accepting message, see the details” is displayed on the screen, and when Taro clicks on the button to “see the details”, the “item exchange screen” where the Taro frame and the Hanako frame are arranged side by side is displayed on the Taro terminal display. At this time, in each of the Taro frame and the Hanako frame, displayed is the item identification information (including descriptions of design, a name, and a price of the item, and an attack capability value and a defense capability value for each of the item and total value thereof) with respect to the game item selected by each of them as the item to be exchanged.

### Third Process

When Taro sees the above “item exchange screen” displayed on the Taro terminal display, and determines to exchange for the game item accepted by Hanako, Taro clicks on the “exchange approval” button on the screen. Then, the network game system performs information processing to substantially exchange the game items of Taro and Hanako. That is, the item ID (a) of Taro's exchanging object is deleted from the Taro's item possession list, and the item ID (a) is recorded on the Hanako's item possession list. At the same time, the item ID (b) of Hanako's exchanging object is deleted from the Hanako's item possession list, and the item ID (b) is recorded on the Taro's item possession list. Further, the status flag of the exchange transaction record of the transaction number 1 is set to “transaction completed.”

### Remarks

In the above-mentioned description, the system measures the elapsed time since the exchange proposal message of the transaction number 1 from Taro to Hanako has been created, and when the transaction is not made even if the predetermined time has passed, the system sets the status flags of the exchange transaction record of the transaction number 1 to “time expired”, and records that the transaction has been canceled as the item management information of Taro and Hanako, which enables sending Taro and Hanako, thereby inhibiting the above “item exchange screen” from being displayed.

When Hanako who saw the exchange proposal message or Taro who saw the exchange accepting message clicks on a “cancel” button on the “item exchange screen”, the system performs information processing to cancel the exchange transaction, similarly to the case of the above-mentioned “time expired”, and enables sending it to the other party.

Taro can perform operations of adding, exchanging, and deleting the item to be exchanged on the above described “item exchange screen” during a time period from the time when sending of the exchange proposal message to Hanako is enabled by his action to the time when the exchange accepting message is sent from Hanako, and such operations allow Hanako to see the “item exchange screen” with the updated information described thereon. Hanako can perform operations of adding, exchanging, and deleting the item to be exchanged on the above described “item exchange screen” during a time period from the time when sending of the exchange proposal message to Taro is enabled by her action to the time when Taro performs operation of approving the exchange, and such operations allow Taro to see the “item exchange screen” with the updated information described thereon. The above functions increase the possibility of making the item exchange transaction.

### Application to Social Media

The method according to the present invention, applied to the network game system as such, is also applicable as a method of exchanging digital items in social media, which is specified by the following matters 1-9.

1. The method is a method of exchanging digital items in social media configured to provide a space for exchanging information of users using association information and user information provided to each personal ID stored in the database, the social media being implemented on a computer system configured to communicate with a plurality of user terminals via a communication network.

2. The user information includes an item possession list containing item identification information to which the digital item possessed by each user is correlated.

3. The digital item is item identification information of the digital item possessed by each user of the social media described as correlated to the item possession list, the digital item enabled to be used by the user in a scene of information exchange in the social media based on a description thereof.

4. The item identification information includes value information, indicating a name, an item ID, an image, characteristics, an attribute, a category, a quantity, a capability, a price, a number of use, a utilization condition, etc., of each digital item, in a scene of information exchange in the social media.

5. A first process is identifying a personal ID (1) as one of parties of the exchange and an item identification information (2) correlated to the item possession list of the personal ID (1) as information related to exchanging items, and enabling sending a message of proposal for exchanging the digital item of the item identification information (2) with something using the item identification information (2) and a personal ID (3) other than the personal ID (1) to the user terminal identified by the personal ID (3).

6. The exchange proposal message (4) includes value information of the item identification information (2).

7. A second process is enabling sending an exchange accepting message (6) showing intention for exchanging with the item identification information (5) to the user terminal of the personal ID (1) when the item identification information (5) of an exchanging object is determined in the item identification information correlated to the item possession list of the personal ID (3) for responding to the exchange proposal message (4).

8. The exchange accepting message (6) includes value information of the item identification information (5).

9. A third process is registering the item ID corresponding to the item identification information (5) and deleting the item ID corresponding to the item identification information (2) in the item possession list of the personal ID (1), and registering the item ID corresponding to the item identification information (2) and deleting the item ID corresponding to the item identification information (5) in the item possession list of the personal ID (3) when the social media determines a response to the exchange acceptance message (6) from the user terminal of the personal ID (1) is acceptance.

### Specific Example of Digital Item

For example, an avatar item (an image for a character to be used as an alter ego in a member's social media by the member of social media) and/or a short story animation work for ornamenting one's blog page is converted into a digital item (making it impossible to be reproduced and taken out), and such a digital item is sold in social media or distributed as reward for having filled out a questionnaire. If such a digital item is managed by social media and is enabled to be exchanged among users, similarly to the above described game item, the pleasure and news hook of social media will increase. The recorded data of beautiful voices of birds, the photo data antique art objects, the data of celebrities' autographs, etc., can be converted into the digital items that are usable only within social media and cannot be reproduced and taken out and also can be used as objects to be exchanged among users.

1. A method of exchanging game items in a network game system configured to enable carrying out a game process allowing playing game on the user terminals using game information provided to each personal ID stored in a database and an associating process allowing exchanging information among users using user information stored in the database, the network game system being implemented on a computer system configured to communicate with a plurality of user terminals via a communication network, the game information including an item possession list containing item identification information to which the game item possessed by each user is correlated, the item identification information including value information of each game item, the method comprising:
a first process of identifying a personal ID (1) as one of parties of the exchange and an item identification information (2) correlated to the item possession list of the personal ID (1) as information related to exchanging items, and enabling sending a message of proposal for exchanging the game item of the item identification information (2) with something using the item identification information (2) and a personal ID (3) other than the personal ID (1) to the user terminal identified by the personal ID (3), the exchange proposal message (4) including value information of the item identification information (2);
a second process of enabling sending an exchange accepting message (6) showing intention for exchanging with the item identification information (5) to the user terminal of the personal ID (1) when an item identification information (5) of an exchanging object is determined in the item identification information correlated to the item possession list of the personal ID (3) for responding to the exchange proposal message (4), the exchange accepting message (6) including value information of the item identification information (5); and
a third process of registering the item ID corresponding to the item identification information (5) and deleting the item ID corresponding to the item identification information (2) in the item possession list of the personal ID (1), and registering the item ID corresponding to the item identification information (2) and deleting the item ID corresponding to the item identification information (5) in the item possession list of the personal ID (3) when the network game system determines a response to the exchange acceptance message (6) from the user terminal of the personal ID (1) is acceptance.

2. The method of exchanging game items according to claim 1, further comprising inhibiting using of the game item of the item identification information (2) in the first process until the exchange is accomplished in the third process, and inhibiting using of the game item of the item identification information (5) in the second process until the exchange is accomplished in the third process.

3. The method of exchanging game items according to claim 1, comprising, when the item identification information to be added or deleted as an exchange target for the personal ID (3) is identified in a time period from the time when sending of the exchange proposal message (4) to the user terminal of the personal ID (3) is enabled to the time when sending of the exchange accepting message (6) to the user terminal of the personal ID (1) is enabled, enabling sending of the information of the addition and/or deletion to the user terminal of the personal ID (3).

4. The method of exchanging game items according to claim 3, comprising, when the item identification information to be added or deleted as an exchange target for the personal ID (1) is identified in a time period from the time when sending of the exchange accepting message (6) to the user terminal of the personal ID (1) is enabled to the time when the network game system determines a response to the exchange acceptance message (6) from the user terminal of the personal ID (1) is acceptance, enabling sending of the information of the addition and/or deletion to the user terminal of the personal ID (1).

5. The method of exchanging game items according to claim 1, comprising, when a plurality of item identification information is described in the exchanging proposal message or the exchange accepting message, sending a total value of the value information of the plurality of the item identification information.

6. The network game system configured to carry out the method of exchanging game items according to claim 1, with a computer system.

7. A method of exchanging digital items in social media configured to provide a space for exchanging information of users using association information and user information provided to each personal ID stored in the database, the social media being implemented on a computer system configured to communicate with a plurality of user terminals via a communication network, the user information including an item possession list containing item identification information to which the digital item possessed by each user is correlated, the digital item being item identification information of the digital item possessed by each user of the social media correlated to the item possession list, the digital item enabled to be used by the user in a scene of information exchange in the social media based on a description thereof, the item identification information including value information in a scene of information exchange in the social media, the method comprising:
a first process of identifying a personal ID (1) as one of parties of the exchange and an item identification information (2) correlated to the item possession list of the personal ID (1) as information related to exchanging items, and enabling sending a message of proposal for exchanging the digital item of the item identification information (2) with something using the item identification information (2) and a personal ID (3) other than the personal ID (1) to the user terminal identified by the personal ID (3), the exchange proposal message (4) including value information of the item identification information (2);
a second process of enabling sending an exchange accepting message (6) showing intention for exchanging with the item identification information (5) to the user terminal of the personal ID (1) when the item identification information (5) of an exchanging object is determined in the item identification information correlated to the item possession list of the personal ID (3) for responding to the exchange proposal message (4), the exchange accepting message (6) including value information of the item identification information (5); and
a third process of registering the item ID corresponding to the item identification information (5) and deleting the item ID corresponding to the item identification information (2) in the item possession list of the personal ID (1), and registering the item ID corresponding to the item identification information (2) and deleting the item ID corresponding to the item identification information (5) in the item possession list of the personal ID (3) when the social media determines a response to the exchange acceptance message (6) from the user terminal of the personal ID (1) is acceptance.

8. The social media configured to carry out the method of exchanging digital items according to claim 7 with a computer system.
